(19) United States
(12) Patent Application Publication
(10) Pub. No.: US 2006/0098797 A1
(43) Pub. Date: May 11, 2006

(54) Method and system for improving the billing of multiple customer services

(75) Inventors: Lesa J. Cauthren, McDonough, GA (US); Nancy W. Rancont, Suwanee, GA (US); Pamela D. Roman, Birmingham, AL (US); Betty M. Wells, Birmingham, AL (US); Douglas B. Unkenholz, Birmingham, AL (US)

Correspondence Address: BELLSOUTH CORPORATION, P.O. BOX 2903, MINNEAPOLIS, MN, 55402-0903, US

(73) Assignee: BellSouth Intellectual Property Corporation

(21) Appl. No.: 10/985,309

(22) Filed: Nov. 10, 2004

(51) Int. Cl. H04M 15/00; H04M 11/00

(52) U.S. Cl. 379/126; 455/405

(57) ABSTRACT

A method and system are provided for improving the billing of multiple customer services. The method includes determining a first billing interval for a first customer service, determining a different billing interval for an additional customer service, determining a periodic billing charge for the first billing interval, determining a periodic billing charge for the additional billing interval, and generating a bill at the end of the first billing interval including a total billing charge. The total billing charge includes the periodic billing charges for the first billing interval and the additional billing interval. The additional billing interval may be based on an installation date of the additional customer service, a predetermined time period, or a preexisting billing interval. If the additional billing interval is based on the installation date, then partial month charges may be avoided for newly added customer services. If additional billing interval is based on the preexisting billing interval, then partial month charges may be avoided for customer services converted to a single billing system.

### TECHNICAL FIELD

The present invention relates to the generation of bills for customer services. More particularly, the present invention is related to an improved method and system for generating a single bill for multiple customer services.

### BACKGROUND OF THE INVENTION

Many service providers, either on their own or through partnerships with other providers, now offer multiple customer services to consumers. For example, a wireline telecommunications service provider which provides wireline and Internet access to its customers may also offer wireless access through a partnership with a wireless service provider. Customers who sign up for multiple services through a single (i.e., target) service provider may be provided the option of having monthly recurring service charges from other service providers billed to a single account and thus appear on a single bill generated by the target service provider. In addition to monthly recurring charges (which may be billed in advance or in arrears), each service provider may also apply other charges including usage based charges (such as 5¢ per minute) as well as non-recurring (or one-time) charges (such as a $4.00 initial setup fee).

Under current billing systems, customers who sign up for multiple services through a target service provider are assigned a billing period (i.e., an invoice date on which a customer's bill is created each month). Any services (or products) purchased by the customer are billed based on the interval established by the assigned billing period. However, customers under current billing systems in which multiple customer services are billed based on a single billing period, may incur additional charges for newly added services or products. For example, when a customer orders a new service, the customer's bill is calculated from the date of service completion. Thus, if a customer service is added on August 14 and the customer is assigned to a billing period running from the 2nd of the month through the 1st of the next month, the customer's September bill might include monthly recurring charges billed in advance (i.e., from September 2 through October 1), partial month charges from the date the new service was added (i.e., from August 14 through September 1), usage based charges from the date the new service was added (i.e., from August 14 through September 1), and non-recurring charges. In other words, under current billing systems, the customer may incur a partial month charge in addition to a full month's charge on the first bill after activation. It is with respect to these considerations and others that the various embodiments of the present invention have been made.

### SUMMARY OF THE INVENTION

In accordance with the present invention, the above and other problems are solved by a method and system for improving the billing of multiple customer services. Preexisting billing intervals for multiple services are maintained so that gap charges are eliminated on the initial bill.

The method includes determining a determining a first billing interval for a first customer service, determining at least one additional billing interval for at least one additional customer service, wherein the at least one additional billing interval is not equivalent to the first billing interval, determining a periodic billing charge for the first billing interval, determining a periodic billing charge for the at least one additional billing interval, and generating a bill at the end of the first billing interval comprising a total billing charge, the total billing charge comprising the periodic billing charges for the first billing interval and the at least one additional billing interval. The customer services may be currently billed customer services or newly billed customer services.

The at least one additional billing interval may be based on an installation date of the at least one additional customer service, a predetermined time period, or a preexisting billing interval for the at least one additional customer service. If the at least one additional billing interval is based on the installation date, then partial month charges may be avoided for newly added customer services. If the at least one additional billing interval based on the preexisting billing interval, then partial month charges may be avoided for customer services converted to a single billing system.

The method may further include disconnecting the first customer service and the at least one additional customer service by determining a disconnect date for the customer services and generating a final bill comprising a final billing charge for the first customer service and a final billing charge for the at least one additional customer service, based on the disconnect date. In generating a final bill comprising a final billing charge for the first customer service and a final billing charge for the at least one additional customer service, based on the disconnect date, the method may include determining whether a time period remains in the first billing interval for the first customer service based on the disconnect date and, if a time period remains in the first billing interval, then calculating the final billing charge for the first customer service based on the remaining time period, determining whether a time period remains in the at least one additional billing interval for the at least one additional customer service based on the disconnect date, and if a time period remains in the at least one additional billing interval, then calculating the final billing charge for the at least one additional customer service based on the remaining time period.

In calculating the final billing charge for the first customer service based on the remaining time period, the method may further include calculating a partial credit based on the remaining time period in the first billing interval and calculating a partial charge based on the remaining time period in the first billing interval. In calculating the final billing charge for the at least one additional customer service based on the remaining time period, the method includes calculating a partial credit based on the remaining time period in the at least one additional billing interval and calculating a partial charge based on the remaining time period in the at least one additional billing interval.

The invention may be implemented as a system, a computing apparatus, or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

These and various other features, as well as advantages, which characterize the present invention, will be apparent from a reading of the following detailed description and a review of the associated drawings.

### BRIEF DESCRIPTION OF THE DRAWINGS

FIG. 1 is a block diagram illustrating a billing system utilized in and provided by the various illustrative embodiments of the invention;

FIG. 2 is a flow diagram illustrating aspects of a process for generating billing charges for multiple customer services, according to an illustrative embodiment of the invention;

FIG. 3 is a chart diagram illustrating the process of FIG. 2, according to an illustrative embodiment of the invention;

FIG. 4 is a flow diagram illustrating aspects of a process for calculating a final billing charge for disconnected services, according to an illustrative embodiment of the invention; and

FIG. 5 is a chart diagram illustrating the process of FIG. 4, according to an illustrative embodiment of the invention.

### DETAILED DESCRIPTION OF THE INVENTION

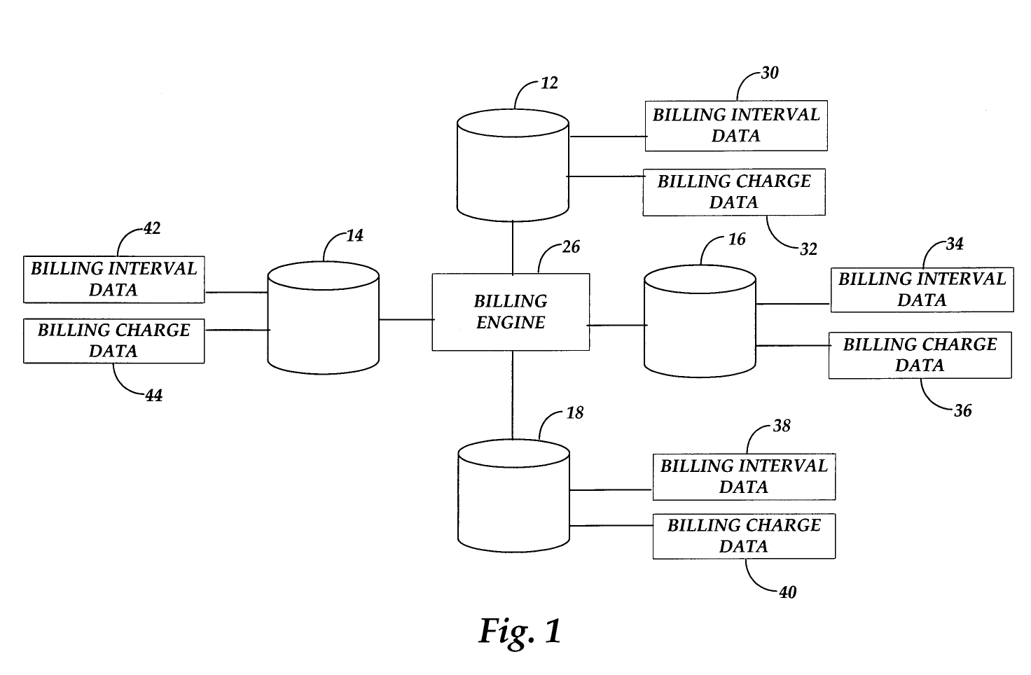

In accordance with illustrative embodiments of the present invention, a method and system for are provided for improving the billing of multiple customer services. Referring now to the drawings, in which like numerals represent like elements, various aspects of the present invention will be described. In particular, FIG. 1 and the corresponding discussion is intended to provide a brief, general description of a suitable system in which illustrative embodiments of the invention may be implemented.

Referring now to FIG. 1, a billing system 10 utilized in and provided by the various illustrative embodiments of the invention system will now be described. As shown in FIG. 1, the billing system 10 includes a billing engine 26 in communication with databases 12, 14, 16, and 18. The database 12 contains billing interval data 30 and billing charge data 32. The database 14 contains billing interval data 42 and billing charge data 44. The database 16 contains billing interval data 34 and billing charge data 36. The database 18 contains billing interval data 38 and billing charge data 40. The databases 12, 14, 16, and 18 may each be associated with a customer service offered by a service provider. For example, in a telecommunications network, the database 12 may be associated with a wireline service provider, the database 14 may be associated with a wireless service provider, the database 16 may be associated with an Internet service provider, and the database 18 may be associated with a long distance service provider.

The billing interval data in the databases 12, 14, 16, and 18 may include current customer billing intervals for each service provider. Each billing interval represents a recurring time period during which charges are assessed for provider services. It will be appreciated that a single customer subscribing to multiple services may have entries corresponding to different billing intervals in multiple databases. For example, a customer billing interval for wireline services in the database 12 may run from the 22nd day of one month to the 21st of the next month while a customer billing interval for wireless services in the database 14 may run from the 3rd of one month to the 2nd of the next month.

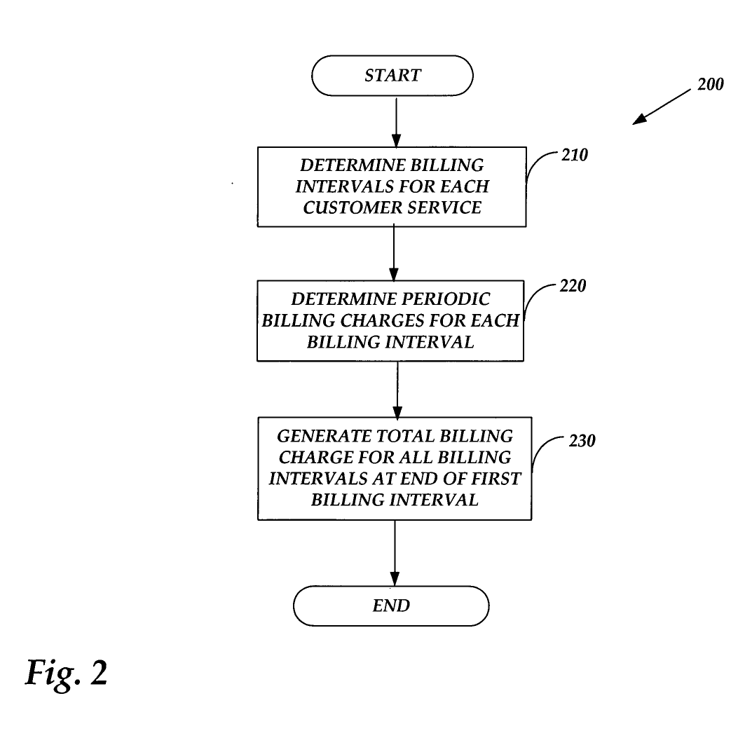

The billing charge data in the databases 12, 14, 16, and 18 includes the monthly recurring charge applied to each billing interval for provided customer services. In accordance with the various illustrative embodiments of the invention, the billing engine 26 is configured to calculate and generate bills for multiple customer services from various providers according to various business rules. For instance, in one illustrative embodiment, the billing engine 26 may utilize the billing interval and billing charge data in the databases 12, 14, 16, and 18 (i.e., pre-existing billing data) to calculate a combined or total charge for multiple customer services. In other illustrative embodiments, the billing engine 26 may be configured to determine the billing interval for each customer service so as to minimize partial month or “gap” charges in generating a total bill for customer services. Those skilled in the art will appreciate that the billing engine 26 may be implemented as a computer program containing instructions which may be executed on a general purpose computer system. The communication of the billing system 26 with the databases 12, 14, 16, 18 may be implemented over a computer network including, but not limited to, a local area network or a wide area network, such as the Internet. Computer networks are well known to those skilled in the art and thus are not discussed further herein. The various operations of the billing engine 26 will be described in greater detail in the description of FIGS. 2-5, below.

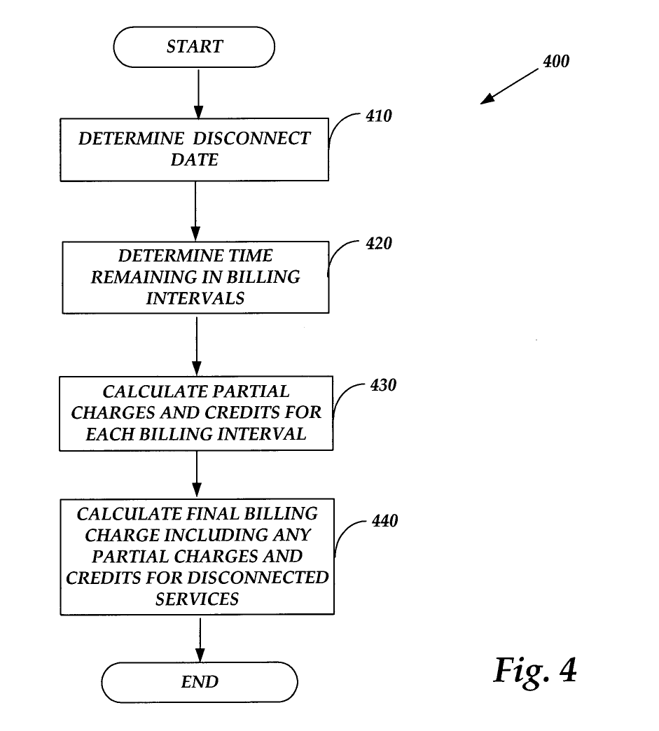

Referring now to FIG. 2, an illustrative routine 200 will be described illustrating a process performed by the billing engine 26 for generating billing charges for multiple customer services, according to an illustrative embodiment of the invention. When reading the discussion of the routines presented herein, it should be appreciated that the logical operations of various embodiments of the present invention may be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated in FIGS. 2 and 4, and making up the illustrative embodiments of the present invention described herein are referred to variously as operations, structural devices, acts, or modules. It will be recognized by one skilled in the art that these operations, structural devices, acts, and modules may be implemented in software, in firmware, in special purpose digital logic, and any combination thereof without deviating from the spirit and scope of the present invention as recited within the claims set forth herein.

The routine 200 begins at operation 210 where the billing engine 26 determines the billing intervals for each customer service. In particular, in one illustrative embodiment, the billing engine 26 may retrieve the billing interval data 30, 42, 34, and 48 in the databases 12, 14, 16, and 18 to determine the current billing intervals. In another illustrative embodiment, the billing engine 26 may determine the billing interval for each customer service based on when the service was added (i.e., installed or activated).

From operation 210, the routine 200 continues to operation 220 where the billing engine 26 determines the billing charges for each billing interval. In particular, the billing engine 26 may retrieve the billing charge data 32, 44, 36, and 40 in the databases 12, 14, 16, and 18 to determine the billing charges.

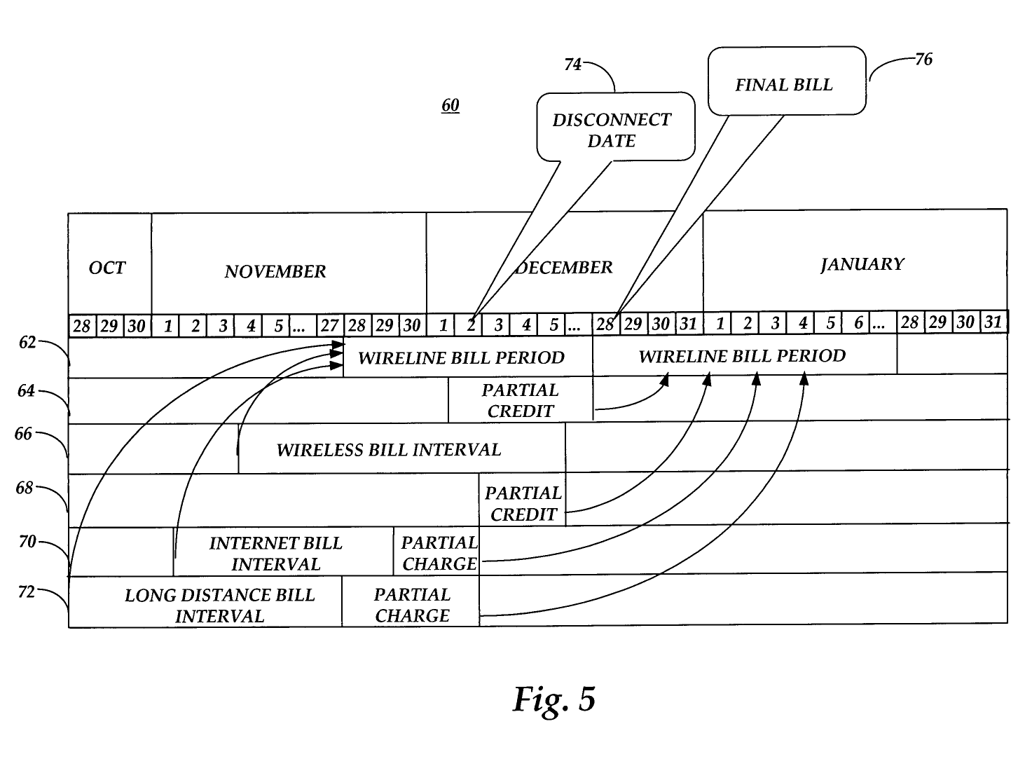

From operation 220, the routine 200 continues to operation 230 where the billing engine 26 generates a total billing charge for the determined billing intervals which will be assessed at the end of a first billing interval. In particular, the billing engine 26 may generate a single bill for billed customer services covering different billing intervals. The total billing charge for all of the billing intervals will be assessed at the end of one of the billing intervals (e.g., the first billing interval). For instance, if a first billing interval for a first customer service runs from the 22nd of the month to the 21st of the next month and a second billing interval for a second customer service runs from the 3rd of the month to the 2nd of the next month, then the bill for both billing intervals services will be assessed on the 21st of the next month (i.e., the end of the first billing interval). It should be understood that the billing intervals for each customer service are not altered during the bill generation process. That is, the billing interval for each customer service is maintained. The routine 200 then ends. An illustration incorporating the routine 200 is described in detail in the following discussion of FIG. 5.

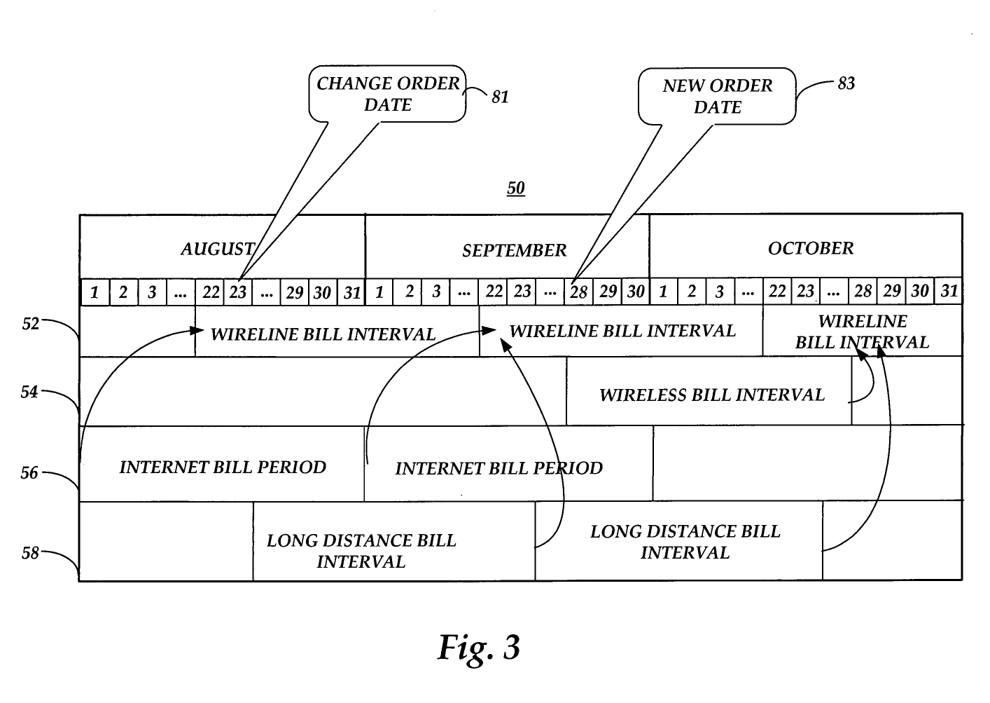

FIG. 3 illustrates a chart 50 describing the generation of total billing charges at the end of a first billing interval as discussed above with respect to FIG. 2. As shown in FIG. 3, the chart 50 comprises a calendar illustrating billing intervals for four billed customer services over a three-month period. Row 52 in the chart 50 shows a billing interval for a wireline service which may also referred to as the first billing interval. As shown in the chart 50, the first billing interval runs from the 21st of one month through the 21st of the next month. Row 54 in the chart 50 shows a second billing interval for a wireless service. It will be appreciated that the second billing interval represents a New Order 83 (i.e., the wireless service was installed or added on September 27). Row 56 in the chart 50 shows a third billing interval for an Internet service which runs from the first of the month through the end of the month. Finally, row 58 in the chart 50 shows a fourth billing interval for a long distance service. It will be appreciated that the fourth billing interval represents a Change Order 81 (i.e., an existing customer service is being added to other customer services being billed to a single account by the billing engine 26).

It will be appreciated that the billing engine 26 may be configured to determine the wireless billing interval from the new order date to avoid the application of partial month charges. For instance, under previous billing methods, if the normal billing interval (e.g., the invoice date) for the wireless service from the wireless service provider is the 2nd of every month, then a new order occurring on the 28th of the month would incur an advance monthly billing charge for the normal billing interval (i.e., from the 2nd of the month to the 2nd of the next month) as well as a partial billing charge from the 28th of the month through the 2nd of the next month). However, in an illustrative embodiment of the present invention (as shown in FIG. 3), since the billing interval is calculated from the new order date, no partial month charges are generated for the wireless service.

The billing engine 26 may also be configured to determine the long distance billing interval from the change order date to avoid the application of partial month charges. For instance, under previous billing methods, change orders were aligned with the billing interval of a primary customer service (e.g., a wireline service). Under this scenario, for example, a change order occurring on the 23rd of the month might be aligned with a primary billing interval for a different customer service occurring on the 21st of the month, resulting in a partial month charge from the 23rd of the month through the 21st of the month in addition to a full month charge billed in advance. However, in an illustrative embodiment of the present invention (as shown in FIG. 3), since the billing interval is calculated from the change order date, no partial month charges are generated for the wireless service.

It should be understood that a single service provider might provide all of the aforementioned customer services. Alternatively, one or more of the services may be provided an associated or “partner” provider which supplies billing information to a primary provider such that the partner's billing charges appear on the primary provider's bill. For instance, in FIG. 3, the wireline provider may be designated as a primary provider which provides wireline, Internet, and long distance services. The wireless provider may be a partner provider which submits its billing information to the primary provider. As discussed above in FIG. 2, the billing engine 26 is configured generate a total bill for all billed services at the end of the first billing interval. Thus, in FIG. 3, the billing for all of the services shown in Rows 52-58 are billed at the end of the billing interval for the wireline service (i.e., the 21st of the month).

Referring now to FIG. 4, an illustrative routine 400 will be described illustrating a process performed by the billing engine 26 for generating billing charges after the disconnection of multiple services. The routine 400 begins at operation 410 where the billing engine 26 determines the disconnect date for the multiple customer services. In particular, the disconnect date may be obtained from one or a combination of the databases 12, 14, 16, and 18 in communication with the billing engine 26. It should be understood that in the description of the present illustrative embodiment, all of the customer services are disconnected on the same date. It will be appreciated, however, that the scope of the invention is not limited to this scenario and that other disconnect scenarios, such as disconnecting one service while maintaining one or more additional services, may also be considered as being within the scope of various illustrative embodiments of the invention.

From operation 410, the routine 400 continues to operation 420 where the billing engine 26 determines the time remaining in the billing intervals for each of the multiple services. In particular, the billing engine 26 determines the number of days remaining in any billing period as compared to the disconnect date to ascertain whether any charges or credits should be attached to a final bill. For instance, if a disconnect date falls within an existing billing interval for a service billed a month in advance of service used, a partial credit may be calculated for the final bill. Conversely, if a disconnect date falls within an existing billing interval for a service billed a month in arrears, a partial charge may be calculated for the final bill.

From operation 420, the routine 400 continues to operation 430 where the billing engine 26 calculates the appropriate charges and credits to be awarded based on the billing intervals of each service provider based on the disconnect date. From operation 430, the routine continues to operation 440 where the billing engine 26 calculates a final billing charge including any partial charges and credits for the disconnected services. The routine 400 then ends. An illustration incorporating the routine 300 is described in detail in the following discussion of FIG. 5 below.

FIG. 5 illustrates a chart 60 describing the calculation of a final billing charge, including partial credits and charges, based on the disconnection of multiple services as discussed above with respect to FIG. 4. As shown in FIG. 5, the chart 60 comprises a calendar illustrating billing intervals for four billed customer services over a three-month period. Row 62 in the chart 60 shows a billing interval for a wireline service, Row 66 in the chart 60 shows a different billing interval for a wireless service, Row 70 in the chart 60 shows still another different billing interval for an Internet service, and Row 72 in the chart 60 shows still another different billing interval for a long distance service. The chart 60 also shows a Disconnect Date 74 of December 2 which corresponds to a date when the billing of all four customer services will cease. The chart 60 also shows a Final Bill date 76 of January 28 which is the date a final bill for the customer services is generated by the billing engine 26.

As discussed above with respect to FIG. 4, the billing intervals for the wireline and wireless services may be billed a month in advance while the billing intervals for the Internet and long distance services may be billed a month in arrears. In FIG. 5, the Disconnect Date 74 falls within the billing intervals for the wireline and wireless services. In particular, with respect to the wireline service, the period from December 3 through December 28 remains, while with respect to the wireless service, the period from November 4 through at least December 5 remains. Since the billings for these services are billed in advance, the billing engine 26 will calculate a partial credit for reach service after the disconnect date which will appear on the Final Bill 76 on December 28. In particular, a partial month credit will be applied for the wireless service from December 2 through December 28 while a partial month credit will be applied for the wireless service from December 2 through at least December 5 as shown in Rows 64 and 68 of the chart 60.

Regarding the Internet and long distance services, the Final Bill 76 will show a partial month charge applied for the Internet service from November 30 through the Disconnect Date 74 of December 2. In addition, a partial month charge will also be applied for the long distance service from November 28 through the Disconnect Date 74 of December 2. The partial month charges will appear on the Final Bill 76 for all of the customer services issued on December 28.

Although the above-described illustrative embodiments of the invention have been described with respect to telecommunications services, those skilled in the art will appreciate that the scope of the invention may include any group of customer services which are provided on a recurring basis. Based on the foregoing, it should be appreciated that the various embodiments of the invention include a method and system for improving the billing of multiple customer services. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for the improved billing of multiple customer services, comprising:
determining a first billing interval for a first customer service;
determining at least one additional billing interval for at least one additional customer service, wherein the at least one additional billing interval is not equivalent to the first billing interval;
determining a periodic billing charge for the first billing interval;
determining a periodic billing charge for the at least one additional billing interval; and
generating a bill at the end of the first billing interval comprising a total billing charge, the total billing charge comprising the periodic billing charges for the first billing interval and the at least one additional billing interval.

2. The method of claim 1, wherein the at least one additional billing interval is based on an installation date of the at least one additional customer service.

3. The method of claim 1, wherein the at least one additional billing interval is based on a predetermined time period.

4. The method of claim 1, wherein the at least one additional billing interval comprises a preexisting billing interval for the at least one additional customer service.

5. The method of claim 1, further comprising disconnecting the first customer service and the at least one additional customer service, wherein disconnecting the customer services comprises:
determining a disconnect date for the customer services; and
generating a final bill comprising a final billing charge for the first customer service and a final billing charge for the at least one additional customer service, based on the disconnect date.

6. The method of claim 5, wherein generating a final bill comprising a final billing charge for the first customer service and a final billing charge for the at least one additional customer service, based on the disconnect date, comprises:
determining whether a time period remains in the first billing interval for the first customer service based on the disconnect date;
if a time period remains in the first billing interval, then calculating the final billing charge for the first customer service based on the remaining time period;
determining whether a time period remains in the at least one additional billing interval for the at least one additional customer service based on the disconnect date; and
if a time period remains in the at least one additional billing interval, then calculating the final billing charge for the at least one additional customer service based on the remaining time period.

7. The method of claim 6, wherein calculating the final billing charge for the first customer service based on the remaining time period comprises calculating a partial credit based on the remaining time period in the first billing interval.

8. The method of claim 6, wherein calculating the final billing charge for the first customer service based on the remaining time period comprises calculating a partial charge based on the remaining time period in the first billing interval.

9. The method of claim 6, wherein calculating the final billing charge for the at least one additional customer service based on the remaining time period comprises calculating a partial credit based on the remaining time period in the at least one additional billing interval.

10. The method of claim 6, wherein calculating the final billing charge for the at least one additional customer service based on the remaining time period comprises calculating a partial charge based on the remaining time period in the at least one additional billing interval.

11. The method of claim 1, wherein the first customer service and the at least one additional customer service are currently billed customer services.

12. The method of claim 1, wherein the first customer service and the at least one additional customer service are newly billed customer services.

13. A system for the improved billing of multiple customer services, comprising:
a first billing database for storing first billing interval data and first billing charge data for a first customer service, wherein the first billing interval data comprises a first billing interval for the first customer service and the first billing charge data comprises a first periodic billing charge for the first billing interval;
a second billing database for storing second billing interval data and second billing charge data for a second customer service, wherein the second billing interval data comprises a second billing interval for the second customer service and the second billing charge data comprises a second periodic billing charge for the second billing interval, and wherein the second billing interval is not equivalent to the first billing interval; and
a billing engine, in communication with the first billing database and the second billing database, wherein the billing engine is operative to generate a bill at the end of the first billing interval comprising a total billing charge, the total billing charge comprising the periodic billing charges for the first billing interval and the second billing interval.

14. The system of claim 13, wherein the billing engine is further operative to disconnect the first customer service and the second customer service by determining a disconnect date for the customer services and generating a final bill comprising a final billing charge for the first customer service and a final billing charge for the second customer service, based on the disconnect date.

15. The system of claim 14, wherein in generating a final bill the billing engine is further operative to:
determine whether a time period remains in the first billing interval for the first customer service based on the disconnect date;
if a time period remains in the first billing interval, then calculate the final billing charge for the first customer service based on the remaining time period;
determine whether a time period remains in the second billing interval for the second customer service based on the disconnect date; and
if a time period remains in the second billing interval, then calculating the final billing charge for the second customer service based on the remaining time period.

16. The system of claim 15, wherein in calculating the final billing charge for the first customer service based on the remaining time period the billing engine is further operative to calculate a partial credit based on the remaining time period in the first billing interval.

17. The system of claim 15, wherein in calculating the final billing charge for the first customer service based on the remaining time period the billing engine is further operative to calculate a partial charge based on the remaining time period in the first billing interval.

18. The system of claim 15, wherein in calculating the final billing charge for the second customer service based on the remaining time period the billing engine is further operative to calculate a partial credit based on the remaining time period in the second billing interval.

19. The system of claim 15, wherein in calculating the final billing charge for the second customer service based on the remaining time period the billing engine is further operative to calculate a partial charge based on the remaining time period in the second billing interval.

20. The system of claim 13, wherein the second billing interval is based on an installation date of the second customer service.

21. The system of claim 13, wherein the second billing interval is based on a predetermined time period.

22. The system of claim 13, wherein the second billing interval comprises a preexisting billing interval for the second customer service.

23. A computer-readable medium containing computer executable instructions which when executed on a computer perform a method for the improved billing of multiple customer services, the method comprising:
determining a first billing interval for a first customer service;
determining at least one additional billing interval for at least one additional customer service, wherein the at least one additional billing interval is not equivalent to the first billing interval; and
determining a periodic billing charge for the first billing interval;
determining a periodic billing charge for the at least one additional billing interval; and
generating a bill at the end of the first billing interval comprising a total billing charge, the total billing charge comprising the periodic billing charges for the first billing interval and the at least one additional billing interval.
